(19) United States
(12) Patent Application Publication
(10) Pub. No.: US 2002/0156767 A1
(43) Pub. Date: Oct. 24, 2002

(54) Method and service for storing records containing executable objects

(76) Inventors: Brian Costa, Collingswood, NJ (US); Michael Ogg, West Windsor, NJ (US); Aleta Ricciardi, West Windsor, NJ (US)

Correspondence Address: Stuart D. Rudoler, Wolf, Block, Schorr and Solis-Cohen LLP, 1650 Arch Street, Philadelphia, PA, 19103, US

(21) Appl. No.: 10/121,382

(22) Filed: Apr. 12, 2002

Related U.S. Application Data
(60) Provisional application No. 60/283,259, filed on Apr. 12, 2001.

(51) Int. Cl. G06F 7/00

(52) U.S. Cl. 707/1

(57) ABSTRACT

The present invention describes a method and service for storing data wherein objects of varying class or class structure may be stored, searched and retrieved. In addition to storing objects which are comprised of flat data such as text and numbers, the service is capable of storing and running objects that are executable methods. By making use of the ability to store and run executable methods within some or all of the records, the service can implement a number of functions in a way that is customizable to each record. Examples of such functions include security, archiving, purging and notification.

### CROSS REFERENCE TO RELATED APPLICATION

The present application claims the benefit of U.S. Provisional Application No. 60/283,259, filed Apr. 12, 2001, the entire disclosure of which is incorporated herein by reference.

### BACKGROUND OF INVENTION

This invention applies to the field of computer storage techniques, including two particular types of storage techniques known as logs and persistent stores. In a log, the information stored there is immutable, i.e. once data is written into the log, it cannot be modified (although, depending on the architecture, data may be deleted). In persistent stores, data may be modified, including by deletion. As a general rule of thumb, logs record the occurrence of a transition from one state to another, including the occurrence of errors or the successful completion of a task, whereas persistent stores hold the current value of relevant system state. This is not meant to be limiting however. One common implementation of logs and persistent stores is through a traditional database (such as a relational database), although simple files and any other form of data collection and recordation have been used. In the setting of this invention, there is no need for the log or persistent store to be relational or query optimized in any particular way.

Logs support the following functionality to users regarding the data stored in them: write (a data element to the log), search (the log for data elements meeting some criteria), read (a data element from the log), and possibly delete (a data element from the log). Logs further support internal management functionality related to their execution efficiency. For example, logs can cluster data elements to make reading or searching for them more efficient. Logs can also defragment—a type of clustering that makes better use of the physical storage medium (such a disk or RAM). Persistent stores also support the modify (a data element) operation. Hereafter we use the term data store to refer to both logs and persistent stores, except when actions specific to one or the other require further clarification.

The term immutable is not meant to imply that it is impossible to change logged data, but that the software implementing the log does not itself expose any mechanisms to do so. Since logs can be stored in computer memory, hard drives, magnetic tapes or optical disks (or any other suitable storage medium) a skilled programmer would be able to modify such records. Some logs however do provide security measures that indicate whenever data have been changed once they have been initially written. A truly immutable log can be created by recording to a medium that cannot be rewritten (such as certain types of optical disks), but then data cannot be expunged or deleted from such logs.

Also, the term immutable is not meant to imply that a record cannot be deleted from the log, only that it cannot be changed other than through deletion. It is even possible to implement deletion in a truly immutable medium (such as optical disk). The concept of deletion is done by marking data elements as “deleted” in a separate table, but not by actually removing them. Whether they “exist” after being deleted is a matter of perspective. The data is still on the medium, but they cannot be accessed via the log software.

A familiar example of a log is the historical record created by hand held computing devices when they synchronize with PCs. Typically, the log records that a synchronization has occurred, how many records were copied from one device to another, and whether the synchronization was successful. Another example of a log may occur when a phone company deletes a user from its active database. Any such deletions might be recorded with specific information (such as the user's name, phone number, address, last monthly usage fee and the date of deletion). The phone company may desire to keep this data for a fixed period of time (to satisfy regulatory demands or in case the customer wishes to reactivate) or forever. In addition, computer system execution logs are maintained for the purposes of root cause analysis and determining security violations such as intrusion detection and unauthorized accesses.

The term data store is used here and is meant to include any collection of objects (which may be flat data or executable methods) stored by a service that has the primary purpose of storing objects. Data stores include logs, databases, Tuple Spaces, (of which JavaSpaces are one example) and persistent stores. The term data store is used instead of database since databases have traditionally been associated with storing only flat data (that is, information) but not live objects that include executable methods. Databases have also generally supported strong notions of query optimization for search and retrieval that exploits this known, flat data structure, which are not necessarily present in other forms of data stores. While a number of the specific embodiments of the invention are described as logs, the invention not meant to be limited to logs.

One difficulty with using databases for logs is that databases have a very rigid structures; the rigidity optimizes for search and retrieval performance but means that all data elements must have the same structure. Each element in a database typically comprises a pre-defined number of fields, and each field must be of a specific kind of data (e.g. integer, character, dollar, date). In large databases, changes to this structure are complex and difficult, and therefore can take considerable time and resources to implement. At the other extreme, when flat (that is, unstructured) files are used, there is no ability to search the stored data elements, and while any data element can be stored as a sequential string of bytes, reconstructing them is extremely difficult. Relatedly, while executable functions (or routines) can be stored (as a sequential string of bytes), the stored functions cannot be executed without reconstructing the element and forcing an external program to invoke the functionality.

The field of this invention is concerned with data stores that can store an unlimited variety of objects, and of particular utility, with objects that embed executable methods. The data stores in this invention can exploit the exposed functionality of these executable methods to increase both the breadth and the depth of their functionality. For example, consider a client of a log that wants to read an object in the log and that the object has a checkPermissions( ) method. Then a log that first invokes the checkPermissions( ) method with the credentials of its client can deny access to objects from insecure or untrusted entities. This is especially important in persistent stores when objects may be modified. (Some databases permit only the object's creator to do so, but this is simplistic and restrictive.) We provide more detailed examples of such active logs (that is, logs that collaborate with the executable objects they store) after first describing the current state of affairs.

Periodic or environmentally-driven operations on the stored data such as cleansing or archiving, have heretofore been performed by external programs or scripts that executed the exposed methods of data storage service and determined what to do with each object. To purge data based on its longevity in the data store, the external program would read( ) each element, examine its date of creation—provided such information was originally designed to be part of the static data structure—and then delete( ) the object. Alternately, the external program would search( ) for all objects created too long ago, then delete( ) each one. This process is cumbersome and among other difficulties does not allow the data store software itself to execute the object or cause it to be executed. While it is certainly possible to store executable methods in existing data stores—for example, a file system stores compiled code—in the prior art, the data store itself cannot execute these methods, treating them only as a sequence of bytes. In particular, data stores such as databases cannot use a stored record's executable code to evaluate or act upon other data in the record. This invention removes these difficulties and inefficiencies by storing executable objects and enabling the store itself to operate on the objects.

Regarding the static, uniform nature of the prior art in data stores, each database implementation of a data store can only store objects of the same predefined class structure, generally limited to simple base types (such as integers and strings) each of which must be in the same specific layout (e.g. 8 character string, then 4 byte integer, then 4 byte float.) In some cases, a class may be defined by the database architect from the base types, such as color, country or job title. Such a construct is known as a structured type. Existing relational databases define for each field what the class should be. If the class for a field changes or a new class is added (or for that matter a new field of an existing record) the entire database must be restructured and sometimes reinitialized. As long as the data is entered as the correct class the database software can usually work with the data as the type that it is. In some cases databases will have free text fields into which any type of data can be written as a series of bytes (as described above for executable objects) but in that event the data loses its character (i.e. its original data type) and is no longer treated by the database as a particular class. This is often the case with log services that treat all data input as text. The inflexibility of existing relational databases and flat files when used for data stores presents many challenges in dynamic computing environments, where services that were not designed initially to operate with each other may call upon each other. More specifically, a data storage service should ideally be able to be called up to store data by many possible clients, some of which may not have knowledge of a predefined data structure because they were preexisting or later integrated from a disparate unit.

Another difficulty found in existing data stores is the purging and archiving of existing data elements in an efficient manner.

Another limitation of existing data stores is that they do not inherently notify other members of the computing environment (e.g. other users, programs) that “interesting” events have occurred within the log.

It is therefore an object of this invention to provide a data storage service that is aware of and retains class and class structure of the objects that it stores, and that can therefore store any data object, without the class structure of that object being defined in advance.

It is another object of this invention to provide a data storage service that can store objects containing executable methods and run or launch these methods while the object is in the control of the data storage service.

It is another object of this invention to provide a data storage service that efficiently purges data and archives data.

It is another object of this invention to provide a data storage service that notifies other services of events occurring within it.

### BRIEF DESCRIPTION OF INVENTION

The present invention describes a method and service for storing data wherein objects of varying class or class structure may be stored, searched and retrieved. In addition to storing objects which are comprised of flat data such as text and numbers, the service is capable of storing and running objects that are executable methods. By making use of the ability to store and run executable methods within some or all of the records, the service can implement a number of functions in a way that is customizable to each record. Examples of such functions include security, archiving, purging and notification.

### BRIEF DESCRIPTION OF THE DRAWINGS

FIG. 1 shows the structure of a typical data store implementing the invention.

FIG. 2 shows a typical class hierarchy.

FIG. 3 shows how the invention can be implemented in a conventional relational database.

### DETAILED DESCRIPTION OF THE INVENTION

The present invention applies the principals of distributed objects and object oriented programming to data stores, such as logs and persistent stores, in order to solve the problems described above. In the present invention, the data storage service itself is capable of treating the objects that are stored within it as “first class objects”; that is, the data storage service is able to recognize an object's class structure and able to invoke any executable methods that are part of a given stored object.

While the specific implementation of a data storage service described herein is written in the Java™ programming language and makes use of its Jini™ Network Technology extension, the invention is not meant to be limited to such specificities. While there are advantages of deploying the method of the invention in a group-aware, distributed computing environment with mobile code, such as Java and Jini, the invention is not meant to be limited to such implementations and may encompass any environment.

In describing the storing of data, the data will be generically referred to herein as an object. This is to emphasize that the stored data may encompass flat data (e.g. customer name, phone number), as well as executable methods on those data (e.g. the routine get Customer( ), set Phone Number( )), or some other type of data. Objects also may be comprised of a plurality of other objects. An object is an instance of a class—the definition of the class specifies the methods and data elements, and the relation to other classes in the system. That is, the class is the abstract definition whereas the object is the specific instance of that definition. Base classes are those that cannot be further decomposed such as the class of Integers, Characters, and Booleans, although this is language dependent. Complex classes can be defined by including these base classes or by inheriting from them. The use of the term class structure describes the particular organization of the data and methods of the object, its class type, and inheritance of each field. That is, an object defined by two integers then one floating point value is not the same as an object defined by one integer, one floating point value and another integer, even when the values within each subclass are identical. In this way, equality between objects ensures that only two objects of the same class are compared

The term record refers to the stored object plus whatever meta-descriptors the data store creates and associates with an object when it is initially stored. Meta-descriptors include traditional meta-data but we use the more generic term since meta-data is restrictive and commonly understood to refer only to flat data. For example, a log might attach a Universally Unique Identifier (UUID) for the object and the process identifier of its creator.

In the current embodiment the UUID is generated by the log service using the time the record was created and the Java Virtual Machine ID of the virtual machine on which the log service is running at the time the record was created. An alternative UUID could be a randomly generated number or a sequential number. Any unique identifier can be used in the meta-descriptor as a UUID and all such identifiers are meant to be incorporated within the scope of the invention.

In the present invention, we also include a true object, that encapsulates additional data and executable code, in the meta-descriptor of each record. We call this object a criterion. For example, in addition to checking the process id against the creator's process id before deleting, the criterion might, in one case, query an external password service, and in another case invoke one or more of the stored object's methods (which might open a dialogue box asking “Are you sure?”). This particular criterion enhances the integrity of the delete( ) operation across all objects, and can be made to be as specific and careful as each stored object needs.

The purpose of criterion is to provide information about, or operations on, stored objects without data storage service either needing to read the object or relying on external, pre-built routines. In the conventional sense the criterion is comparable to keywords used in databases of text files or meta-tags that are embedded in web pages for search engines to read. However, a unique aspect to this invention is that the criterion can also be methods, which the data storage service runs or has run for it.

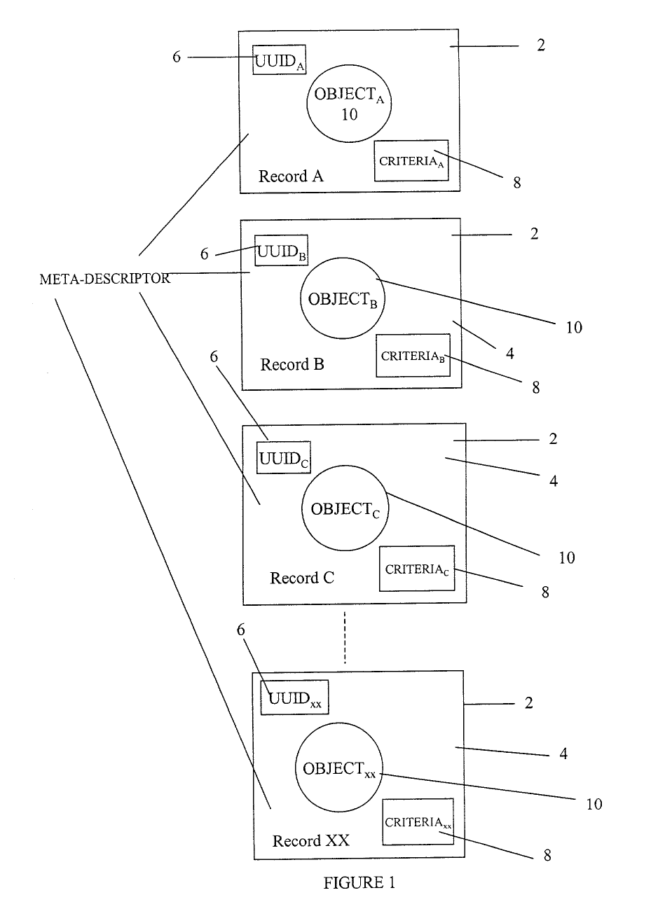

FIG. 1 shows a particular embodiment of the current invention. In FIG. 1, a data store comprised of a plurality of records 2 is shown. Each record 10 is comprised of an object 10 (which may in turn be further comprised of a plurality of objects) and a meta-descriptor. 4 The meta-descriptor is comprised of a universally unique identifier 6 (UUID) and a criterion 8 (which may in turn be comprised of an object). The benefit of the structure of records 2 shown in FIG. 1 is that the object 10 within one record 2 may be an instance of a different class and class structure than the object within another record 2. The result is a data storage service with no predefined structure where records 10 can encapsulate the structure desired by the client program calling the service.

By creating a data store with the architecture described above, the log may be searched in many different ways. Records can be accessed by their UUID, if it is known (e.g. return record with UUID equal to xyz), by searching the criteria of the meta-descriptor (e.g., assuming zip codes is a criterion, return all records that have a zip code equal to 19004), by class of the object or the criterion (whether the object's class, an ancestor in the class hierarchy, or the criterion's class), or by the data in the object. Assume, for instance, a class hierarchy of objects relating to job position as follows:

Java.lang.Object

com.valaran.project.Employee extends Object

com.valaran.project.SalesPerson extends Employee

com.valaran.project.SalesManager extends SalesPerson Further assume that there is a logged record that contains an object of type SalesManager. Then that record can be selected by specifying the retrieval of objects of type “SalesManager”—the object's direct type—or by specifying the retrieval of objects of type “SalesPerson” or “Employee”, or “Object”—any class in the class chain of the actual object that was stored.

Records can be selected by comparing their explicit data members to the search parameters (as is done in standard SQL), or by executing their methods and using the returned values in the selection evaluation. Note that the client requesting records from the log service does not need to know the structure of all records in the log. By requesting that the log service return only those objects with the desired class structure, the requesting client receives only records with the class structure it expects.

In one embodiment of the invention a method that is capable of reading the object is comprised of both data and a routine that is capable of reading the data. Assuming that another service has requested that the log service search for all records that match a certain criterion, when the log service comes to a record with object type that is a method (i.e. executable), it executes the method in order to read the attached data.

In addition to providing a data store with an infinitely flexible data architecture, the ability to execute the methods embedded in each stored object provides for a wide variety of possibilities. For instance, when searching for a record based on some search criteria, the data storage service can cause the execution of a record's executable routine, and any return value from that execution can be used as part of the evaluation of whether that specific record “matches” the selection criteria. This is different from the prior art where the executable must be loaded to a separate service in order to execute. For example, in classic database software (such as Oracle or SQL), the database software cannot execute any foreign routines stored in the database, it merely extracts the bits and bytes of the routine and makes them available for another program to execute. Specifically, the present invention allows for data stores that can execute routines stored within each object.

In one embodiment (alternate, and a preferred embodiment are supplied below), if an object has a check Permissions( ) method, the data storage service will execute it passing along the client's credentials before say reading or writing; if the object does not have such a method, the data storage service will simply honor the client's request. Similarly, the data storage service could implement purging, backup or archiving according the each stored object's preference; if the object has a timeToLive( ) method, the data storage service could execute it, or cause it to be executed, periodically. In an alternate embodiment, the data storage service can simply pass any executable object to an external thread upon any request for access to the object, and run the executable methods.

In the preferred embodiment, the meta-descriptor criterion implements the uniform methods invokeOnEntry( ) and/or invokeOnAccess( ). These methods could either invoke methods directly on the stored object or on a service external to the data storage service. The point is that the individual criterion object implements invokeOnEntry( ) and/or invokeOnAccess( ) however it desires—check password, check time-to-live, notify or archive.

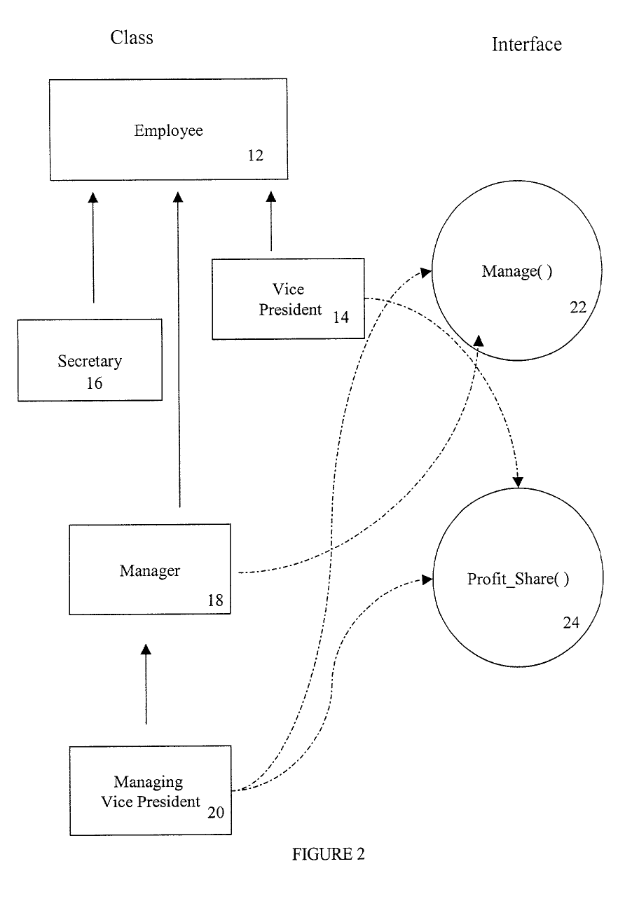

Objects may also represent instances of certain methods (routines) and interfaces (groups of methods). The data store may also be searched by methods. A typical hierarchy is shown in FIG. 2 for an employee record database. In FIG. 2, an object of class type Managing Vice President 20 inherits class type Manager 18 and Employee 12 as well as implements interfaces Manage( ) 22 and Profit_Share( ) 24. A data store may be searched all records for objects of class type Employee 12 in which case all records with objects of class Employee 12, Manager 18, Managing Vice President 20, Vice President 14 and Secretary 14 would be returned. By comparison, a search for class type Manager 18 would only return records with objects of type Manager 18 and Managing Vice President 20. Likewise the records may be searched for objects that implement Profit_Share( ) 24 in which case on objects of class Vice President 14 and Managing Vice President 20 would be returned.

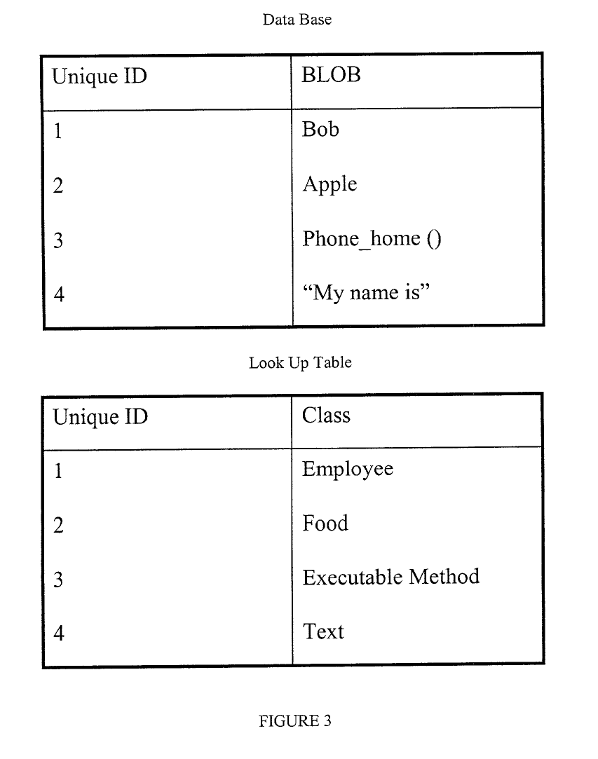

It is also possible to implement the invention in a conventional relational database. Each record would consist of a common data type known as a Binary Large Object (“BLOB”) or the equivalent. There would also be a lookup table in the database that contained a reference to each record and the data structure of the data in the BLOB. The database software when writing data into each BLOB would write to the table the class structure of the data in the BLOB and perhaps other meta-descriptors. When retrieving the BLOB, the software would reference the table in order to reconstitute the binary object into the correct data type. Such a database is shown in FIG. 3. Alternatively, the database could be a string of records which consists of a BLOB and the data structure for that BLOB.

As noted before, by embedding live objects (i.e. executable methods) into a data storage service, and by incrementally extending the functionality of the store to execute those objects, many enhancements and applications are possible. While we generally refer to an executable object being stored within a record, in fact what may be stored is a reference to a location where the method can be found. One additional advantage to the invention is that multiple methods for records can be executing simultaneously without necessarily burdening the data storage service. For example, if each record has an object implementing notification, each record may have a different type of notification routine, and each routine can run in parallel instead of waiting for the data storage services to executed notification serially. Also, any reference to a data storage service executing an object is meant to include the data storage service having the object executed on its behalf elsewhere in the computing environment (locally or in a remote system).

The following is a description of three useful applications of this invention to accomplish notification, security and purging of old records. It will be noted that in some cases these applications can be embedded directly into the service itself, but greater flexibility and scalability is achieved by embedding the application into each data record or the meta-descriptor criterion, so that the application can be tailored to each object in the store instead of being standard for all objects. These three applications are merely representative applications demonstrating the usefulness of embedding live objects with records and are not meant to in any way limit the scope of the invention.

Notification

One particular embodiment of this invention is the ability of a log service to notify other members of a distributed environment of events that are specific to the logging of, or state of, objects. In a distributed environment this can be handled in a number of different ways. Other services may be other programs executing on the same computer, remote computers, or even hardware devices. In one embodiment when the log service registers with a lookup service it describes, in its attributes descriptor which events that can be subscribed to. For instance a log service may register that it emits events whenever a record is read or deleted. Interested entities in the system can register with the event-notification mechanisms available, to receive such events. In some systems, the log service itself can implement the event-notification; in others, a separate publish-subscribe mechanism would manage events. In an alternate embodiment, the proxy distributed to clients of the log service would itself contain a method to explicitly register the client to receive events generated by the log service.

The registration process may involve the interested party specifying a template that indicates what types of events the party wishes to be notified of, or it may be the adherence to an accepted event processing framework. An example of this is that a security service may wish to be notified whenever entries in the log service indicate that computer system login was denied, or it may wish to be notified whenever a client is denied access to a logged object. This approach of proactive notification from the log service to other interested services is different from the more common approach of having interested services continually poll the log and review its contents. In a Jini environment either embodiment is possible: the log service can provide the necessary code for such registration within the proxy it registers with a lookup service, or it could advertise the events it announces assuming that clients are aware the mechanisms of Jini events. Once registration is completed, the log service notifies the subscribing service of any events that meet those criteria.

In the preferred embodiment is for the log service to exploit and expose a notify( ) method that may be present within the logged records themselves. Preferable the notification routine is embedded as a method in the criterion of the record, whether explicitly as a method of the event notification subsystem, or generically as the method invokeOnEntry( ) which then uses the various methods of the event notification subsystem. The generic method invokeOnEntry( ) is a powerful construct in that it can handle whatever activities the record desires—time to live analyses, notification—that are specific to the record's initial creation. The important aspect of invokeOnEntry( ) is that it requires the least amount of specific support from the log service; that is, invokeOnEntry( ), whether as part of the criterion or as part of the stored object, enhances the functionality of the storage service simply, and in a way that is tailored to each object.

Returning to notification in particular, if the record is read in such a way that notification is warranted these mechanisms emit the proper events to all currently registered listeners. For example, if the log service can be written such that whenever there is a method in the criterion of type notify (or alternately called notify( )), it invokes the notification method embedded in the record whenever it is asked to operate on the object. The notification routine might e-mail customer service, write to another log service table, or notify another service, or it might notify security only if this call was part of a deletion. In this embodiment it is important to note that for each record the notification event and parties might be different.

Since the execution of methods can be part of the comparison process in the embodiment described, and since the code that can be executed is not limited, then another form of notification is possible by having the method used in the comparison also serve as the notification agent.

The architectures described in the previous two routines may also be blended such that when a notice method embedded in the record is invoked, the method sends notice to all services that have registered with the log service for notification (or notification of a particular type of event). Obviously, many other permutations of such notification routines can be implemented based on the disclosure set forth herein, and all such implementations are meant to be incorporated within the scope of the described invention.

Purge (Time-To-Live)/Archive

Another important embodiment of the present invention is an efficient means of purging records at a desired time. Again, due to the dynamic nature of the log structure this might comprise different times to live for different records within the same log. For example, some records may need to live for a certain time from the date of their creation, while other records may need to be deleted after 100 new records are entered.

In one embodiment it can be assumed that all records have a time to live that is defined as a time elapsed since the occurrence of a specified event. The event might be the same for each record (in which case in can be coded into the log service) or it might be a different event for each record. Alternatively the criterion may have a timeToLive( ) method that is invoked when the record is entered in the log; that method is, or launches, a listener for the event then after the desired time from the event's occurrence invokes the delete( ) method on the log service. In yet another alternative embodiment, each record comprises the generic method invokeOnEntry( ) as above, to handle time to live analyses. The triggering event might be date of creation, end of quarter, the closing of a trouble ticket, the (de)activation of an account, or the existence of 100 new records. (In the latter case the method would return a time-to-live of equal to zero if there were 100 new records.) Taking the implementation of time to live in the generic method invokeOnEntry( ) as representative for all embodiments, that method is itself a listener, or launches a separate listener, for the specified triggering event (the triggering event as well as the time that will elapse after its occurrence before the record is purged are part of the criterion). After receiving notification of the event's occurrence (through whatever event subsystem is available), elapsed time is measured and finally the delete( ) method of the log service is invoked.

It should be understood that, alternative methodologies can also be used. A deletion routine can be run at fixed intervals that reads or invokes the time-to-live criterion from each record and deletes expired records. Again, due to the flexible implementation of the log, the deletion routine can be designed to ran only on those records that contain a criterion or objects with types time_to_live (either data or method).

While in this example implemented a record deletion routine, which is a common problem in industry, record deletion is by no means the only activity a storage service may perform after an event's occurrence. For example, the storage service can execute a routine that notifies an operator that data corruption may have occurred if a check sum method in a record returns a negative value.

Similar techniques can be used so that a record can contain a method that executes and checks do see whether its record should be archived (backed up). This may be based on whether the record has changed or some time period. In addition to different records using different back up methods, different records can be archived to different storage systems. The archive routines for various records can be run in parallel thus achieving greater speed in the backup.

Again, the flexibility of having each record contain its own archive method allows tremendous flexibility, scalability, and parallel processing.

Security

Security is another important attribute that can also be readily implemented using the described storage service. For example, if a record contains a criterion called password, it might invoke a method that requests a password from the querying client, and only after the correct password is returned (the correct password can being stored as a criterion or can be ascertained using an external security service), would any activity be permitted by that client on that record. Once the security routine is invoked, it returns the object in the record of the client properly responds to the routine. Alternatively, an authentication process using either of public or private key system could be invoked. Finally, each record may implement a generic method called invokeOnAccess( ) which is similar to invokeOnEntry( ) in that it handles, in a record-specific manner, policies related to accessing each object. Security is one such example of an access policy. The generic method invokeOnAccess( ) is a powerful construct in that it can handle whatever activities the record desires—security, notification—that are specific to the record being accessed. The important aspect of invokeOnAccess( ) is that it requires the least amount of specific support from the log service; that is, invokeOnAccess( ), whether as part of the criterion or as part of the stored object, enhances the functionality of the storage service simply, and in a way that is tailored to each object.

Returning to security, the particular security implementation and protocol is not important to the invention and all known and future security protocols are meant to be within its scope. It is also possible to store the security routine in the object or criterion so that each record may have a different (or no) security routine. This makes the log system highly flexible and

scalable since instead of the log service executing security serially, each record can execute its own security in parallel. Also, clients that store highly sensitive objects can embed a very sophisticated security method in the record, while clients with less important data can embed simpler security methods. A security method could also simply return the desired object, thus implementing “no security”.

While in general the description herein has assumed that there is a single data storage service performing all of the functions, it is also possible to implement the invention with multiple services each performing various functions. For instance, one service might write to a log, while another might read and search that log. Also a data storage service may be written to by multiple data storage services or a single data storage service might access multiple data stores. All such permutations are meant to fall within in the scope of the disclosed invention.

It should be noted that the difference between what is stored in the object, the meta-descriptor (the criterion) is somewhat arbitrary. Any of the data or methods described as being criterion could just as easily be a data or method in the object. The logical difference generally being that those things which are criteria are generally designed to provide information about the underlying object or act interact with log service. However, this distinctions are not necessary to the invention and the data architect could implement the criterion and object in any way. Indeed, records can be written with no criterion, and, if a UUID is included in the object, no meta descriptor is required.

It should further be noted that the embedding of methods (i.e. live objects or executable routines), in each object, is not necessary and may even be inefficient in terms of storage requirements. Any implementation using a stored method could alternatively be implemented using a pointer or call to a method stored elsewhere in the environment, whether it is available through a look up service, or stored in a separate table of methods. This architecture might be preferable where a method is stored a large number of times or where a method is relatively large in comparison to the static data in the record. On the other hand if storage medium is inexpensive and speed is critical, storing the executable for each method in the record may be desirable. The invention disclosed is meant to encompass either architecture or a blend thereof.

It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

What is claimed is:

1. A storage service comprised of:
a storage medium to which records can be written;
a first software routine for receiving an object that is comprised of an executable method and writing the object to the storage medium as a record; and
a second software routine for reading the record and causing the method to be executed.

2. The data storage service of claim 1 wherein the data storage service returns the result of the executable method.

3. The data storage service of claim 1 wherein the executable method implements a security procedure.

4. The data storage service of claim 1 wherein the executable method implements a procedure that notifies other services of an event.

5. The data storage service of claim 1 wherein the executable method implements a procedure to determine if the record to which it belongs should be deleted.

6. The data storage service of claim 1 wherein the executable method implements a procedure to determine if the record to which it belongs should be backed up.

7. The data storage service of claim 1 wherein the executable method is a reference to an executable routine stored outside the record.

8. The data storage service of claim 1 wherein the first software module writes objects of different classes.

9. The data storage service of claim 1 wherein for each record the data storage service writes within that record, the class structure of the object stored in that record.

10. The data storage service of claim 1 wherein the first software routing further creates a unique identifier associated with the object and writes the unique identifier to the record.

11. The data storage service of claim 1 wherein there are a plurality of records and the second software routine causes a plurality of executable methods to run in parallel.

12. A log comprised of a plurality of records wherein each record is comprised of:
a unique identifier; and
an object wherein at least one object in the plurality of records is comprised of an executable method.

13. The log of claim 12 wherein the executable method is a reference to an executable routine stored outside the record.

14. The log of claim 12 wherein a first record has an object of a first class and a second record has an object of a second class.

15. The log of claim 12 wherein the class and class structure of each object is determined when each object is stored.

16. The log of claim 12 wherein each record is further comprised of a criterion.

17. The log of claim 16 wherein the criterion is comprised of a key word, class, class structure, class type, object, executable method or a reference to an executable method.

18. The log of claim 12 wherein in a record is comprised of a plurality of objects.

19. The log of claim 12 wherein the executable method implements security, archiving, purging, or notification.

20. A method of storing objects in a data store comprising:
receiving an object to be stored;
generating a unique identifier associated with the object;
determining the class structure of the object;
writing the object, unique identifier and class structure to a storage medium.

21. The method of claim 20 wherein the data store is a log, a database, a relational database, a file system, or a Tuple space.

22. The method of claim 20 wherein the object, unique identifier and class structure are stored as a single record.

23. The method of claim 20 wherein the object is written as binary large object and the class structure is stored in a table.

24. The method of claim 23 wherein the data store is a relational database.

25. The method of claim 20 wherein the class structure is comprised of one or more items selected from the group consisting of class, class super structure, method signature, interface specification and inheritance.

26. The method of claim 20 wherein the steps are repeated for different objects of different class structure.

27. The method of claim 20 wherein the class structure of the object is determined by the client storing the object.

28. The method of claim 20 wherein the object is comprised of an executable method, an integer, a floating point number, a text string, a date, a language supported base type, or a structured type.

29. The method of claim 20 wherein the object is an executable method which implements security, archiving, purging or notification.

30. A computer readable medium containing instructions for controlling a computer system to perform a method of storing objects in a data store comprising
receiving an object to be stored;
generating a unique identifier associated with the object;
determining the class structure of the object;
writing the object, unique identifier and class structure to a storage medium.

31. The computer readable medium of claim 30 wherein the data store is a log, a database, a relational database, a file system, or a Tuple space.

32. The computer readable medium of claim 30 wherein the object, unique identifier and class structure are stored as a single record.

33. The computer readable medium of claim 30 wherein the object is written as binary large object and the class structure is stored in a table.

34. The computer readable medium of claim 33 wherein the data store is a relational database.

35. The computer readable medium of claim 30 wherein the class structure is comprised of one or more items selected from the group consisting of class, class super structure, method signature, interface specification and inheritance.

36. The computer readable medium of claim 30 wherein the steps are repeated for different objects of different class structure.

37. The computer readable medium of claim 30 wherein the class structure of the object is determined by the client storing the object.

38. The computer readable medium of claim 30 wherein the object is comprised of an executable method, an integer, a floating point number, a text string, a date, a language supported base type or a structured type.

39. The computer readable medium of claim 30 wherein the object is an executable method which implements security, archiving, purging or notification.

40. A method of reading records from a data store comprised of:
receiving a request for records with objects of a particular class structure;
determining the class structure of at least one object in each record; and
returning the records with an object that match the requested class structure;
wherein each record is comprised of at least one object and there are objects of varying class structures within the data store.

41. The method of claim 40 wherein the class structure is comprised of one or more items selected from the group consisting of class, class super structure, method signature, interface specification and inheritance.

42. The method of claim 40 further comprising the step of invoking the object when it is of a class that is executable.

43. The method of claim 42 wherein the object invoked implements security, archiving, purging or notification.

44. The method of claim 40 wherein a record contains a criterion and the class structure for the object within a record is read from the criterion.

45. The method of claim 40 wherein the class structure is stored in the record as part of an object.

46. The method of claim 40 wherein the class structure for an object in a record is determined by reading the object into memory and comparing the object to a set of known class structures and selecting the class structure that most closely fits the object.

47. The method of claim 40 wherein the data store is a log, a database, a relational database, a file system or a Tuple space.

48. A computer readable medium containing instructions for controlling a computer system to perform 40.

49. A computer readable medium containing instructions for controlling a computer system to perform a method of reading records from a data store comprised of:
receiving a request for records with objects of a particular class structure;
determining the class structure of at least one object in each record; and
returning the records with an object that match the requested class structure;
wherein each record is comprised of at least one object and there are objects of varying class structures within the data store.

50. The computer readable medium of claim 49 wherein the class structure is comprised of one or more items selected from the group consisting of class, class super structure, method signature, interface specification and inheritance.

51. The computer readable medium of claim 49 further comprising the step of invoking the object when it is of a class that is executable.

52. The computer readable medium of claim 51 wherein the object invoked implements security, archiving, purging or notification.

53. The computer readable medium of claim 49 wherein a record contains a criterion and the class structure for the object within a record is read from the criterion.

54. The computer readable medium of claim 49 wherein the class structure is stored in the record as part of an object.

55. The computer readable medium of claim 49 wherein the class structure for an object in a record is determined by reading the object into memory and comparing the object to a set of known class structures and selecting the class structure that most closely fits the object.

56. The computer readable medium of claim 49 wherein the data store is a log, a database, a relational database, a file system or a Tuple space.

57. A method of embedding security in data store comprising:
storing a first object in a record in connection with a second object in the record wherein the first object is an executable method which returns the second object as a result;
executing the first object;
the first object requiring a security protocol;
providing the correct response to the security protocol to the first object;
the first object returning the second object;

58. The method of claim 57 wherein the security protocol is password access control, verification, public key encryption, private key encryption, secure sockets layer, authentication, non-repudiation or authorization.

59. The method of claim 57 wherein in the security protocol is executed as a separate routine from the data store service.

60. The method of claim 57 wherein in the data store is a log, a database, a relational database, a file system or a Tuple space.

61. The method of claim 57 wherein there are a plurality of records implementing at least two different security protocols.

62. The method of claim 61 wherein one of the two different security protocols is no security.

63. A data store containing a first record comprised of:
a first object being a first executable method that implements a first security protocol; and
a second object stored in connection with the first object;
wherein the executable method returns the second object as a result upon being provided with a proper response to the first security protocol.

64. The data store of claim 63 wherein the security protocol is password access control, verification, public key encryption, private key encryption, secure sockets layer, authentication, non-repudiation or authorization.

65. The data store of claim 63 wherein in the security protocol is executed as a separate routine from the data storage service.

66. The data store of claim 63 wherein in the data store is a log, a database, a relational database, a file system or a Tuple space.

67. The data store of claim 63 further comprised of a second record wherein the second record is comprised of:
a third object being a second executable method that implements a second security protocol; and
a fourth object stored in connection with the third object;
wherein the second executable method returns the forth object as a result upon being provided with a proper response to the second security protocol.

68. The data store of claim 67 wherein the first security protocol and the second security protocol are the same.

69. The data store of claim 67 wherein the first security protocol and the second security protocol are different.

70. The data store of claim 67 wherein one of the security protocols is no security.

71. A method of purging records from a data store comprising the steps of:
reading a record;
executing an object stored within the record to determine if the record should be deleted;
deleting the record if the result of the object indicates the record should be deleted; and
repeating the prior three steps for a plurality of records;

72. The method of claim 71 wherein there are at least two different objects which use two different procedures to determine whether to delete the record in which each is embedded

73. The method of claim 71 wherein the object determines from data in the record the time remaining before the record should be deleted.

74. The method of claim 71 wherein the object is stored within the record.

75. The method of claim 74 wherein the object is stored within a criterion.

76. The method of claim 71 wherein the data store is a log, a database, a relational database, a file system or a Tuple space.

77. The method of claim 71 wherein the objects in a plurality of records are executed in parallel.

78. A method of archiving records in a data store comprising the steps of:
reading a record;
executing an object stored within the record to determine if the record should be archived;
copying the record to a storage medium if the result of the object indicates the record should be archived; and
repeating the prior three steps for a plurality of records;

79. The method of claim 78 wherein there are at least two different objects which use two different procedures to determine whether to delete the record in which each is embedded.

80. The method of claim 78 wherein the object determines from data in the record the time remaining before the record should be archived.

81. The method of claim 78 wherein the object is stored within the record.

82. The method of claim 81 wherein the object is stored within a criterion.

83. The method of claim 78 wherein the data store is a log, a database, a relational database, a file system, or a Tuple space.

84. The method of claim 78 wherein the objects in a plurality of records are executed in parallel.

85. A method of notifying other services of events within a data store:
performing an operation on a record in a data store;
executing a notification routine stored within the record to determine if any services should be notified of the operation;
notifying any services indicated by the notification routine;

86. The method of claim 85 wherein there are a plurality of records and at least two different notification routines.

87. The method of claim 85 wherein the operation is reading, writing, deleting or modifying a record.

88. The method of claim 85 wherein the data store is a log, a database, a relational database, a file system or a Tuple space.

89. The method of claim 85 wherein there are a plurality of records and a plurality of notification routines are executed in parallel.
